(19) United States
(12) Patent Application Publication
(10) Pub. No.: US 2014/0074675 A1
(43) Pub. Date: Mar. 13, 2014

(54) DIGITAL RECEIPT MANAGEMENT

(71) Applicants: Matthew A. Calman, Charlotte, NC (US); Julie Mann, Charlotte, NC (US); Glenn Crossman, Matthews, NC (US)

(72) Inventors: Matthew A. Calman, Charlotte, NC (US); Julie Mann, Charlotte, NC (US); Glenn Crossman, Matthews, NC (US)

(73) Assignee: BANK OF AMERICA CORPORATION, CHARLOTTE, NC (US)

(21) Appl. No.: 13/612,046

(22) Filed: Sep. 12, 2012

(51) Int. Cl. G06Q 40/00

(52) U.S. Cl. 705/35

(57) ABSTRACT

Systems, methods, and computer program products are provided for managing digital receipts. The system includes a computer apparatus including a processor and a memory; and a digital receipt management software module stored in the memory. The software module includes executable instructions that when executed by the processor cause the processor to receive a transaction record including information relating to a transaction. The system then determines a user account associated with the transaction record based on the information; associates the transaction record with a transaction in the user account; and creates a digital receipt based on the transaction record and the account history. The digital receipt is stored in association with the transaction in a digital receipt mailbox and provided to the user when the user accesses the transaction. Special offers, supplemental information, and recommendations may also be provided in the digital receipt.

### BACKGROUND

Consumers often make purchases at various locations and stores during any given time. Records of the purchases are typically provided by merchants at the point of sale in the form of a paper receipt. Email receipts may also be provided, such as those emailed to purchasers by online retailers. These receipts have non-standard formats, lack consistent placement, and may exclude relevant pieces of information. It is difficult to categorize individual products purchased based on the receipts. Further, the information contained in paper and online receipts is static and cannot be easily updated, modified, or supplemented.

### BRIEF SUMMARY

Embodiments of the present invention provide a system for managing digital receipts. The system includes a computer apparatus including a processor and a memory; and a digital receipt management software module stored in the memory. The software module includes executable instructions that when executed by the processor cause the processor to receive a transaction record, wherein the transaction record comprises information relating to a transaction; determine a user account associated with the transaction record based on the information; and associate the transaction record with a transaction in the user account. In some embodiments, the user account includes an account history. The system then creates a digital receipt based on the transaction record and the account history and stores the digital receipt in association with the transaction. In some embodiments, the system provides the digital receipt to the user when the user accesses the transaction.

In some embodiments, the module is further configured to determine if the user is eligible for an offer based on the digital receipt. Additionally, the module may be configured to provide the offer to the user when the user is determined to be eligible. In some embodiments, the module is further configured to extract information from the transaction record; categorize the information extracted from the transaction record; and store the categorized information in a formatted digital receipt. For example, a format of the formatted digital receipt is customizable by a user. In some embodiments, the user supplements the transaction record with a user record, such as an audio recording, a picture, a video, and a text note. In a still further embodiment, the module is further configured to evaluate the transaction record to determine the product or process purchased; determine supplemental information associated with the product or process purchased; and provide the supplemental information associated with the product or process purchased in the digital receipt.

In another aspect of the invention, a computer program product for managing digital receipts is provided. The computer program product includes a non-transitory computer readable storage medium having computer readable program code embodied therewith. The computer readable program code includes a computer readable program code configured to receive a transaction record, wherein the transaction record comprises information relating to a transaction. The computer program product also includes a computer readable program code configured to determine a user account associated with the transaction record based on the information; a computer readable program code configured to associate the transaction record with a transaction in the user account, wherein the user account comprises an account history; and a computer readable program code configured to create a digital receipt based on the transaction record and the account history. In some embodiments, the computer program product includes a computer readable program code configured to store the digital receipt in association with the transaction. In still further embodiments, the computer program product includes a computer readable program code configured to provide the digital receipt to the user when the user accesses the transaction.

In a further embodiment, the computer program product includes a computer readable program code configured to determine if the user is eligible for an offer based on the digital receipt. In a further embodiment, the computer program product also includes a computer readable program code configured to provide the offer to the user when the user is determined to be eligible. In some embodiment, the computer program product also includes computer readable program code configured to extract information from the transaction record; categorize the information extracted from the transaction record; and store the categorized information in a formatted digital receipt. For example, the format of the formatted digital receipt is customizable by a user. In some embodiments, the user supplements the transaction record with a user record, such as an audio recording, a picture, a video, and a text note. In further embodiments, the computer program product also includes computer readable program code configured to evaluate the transaction record to determine the product or process purchased; determine supplemental information associated with the product or process purchased; and provide the supplemental information associated with the product or process purchased in the digital receipt.

In a still further aspect of the invention, a method for managing digital receipts is provided. The method includes receiving a transaction record, wherein the transaction record comprises information relating to a transaction; determining, via a computing device processor, a user account associated with the transaction record based on the information; and associating the transaction record with a transaction in the user account, wherein the user account comprises an account history. The method then creates, via a computing device processor, a digital receipt based on the transaction record and the account history. The digital receipt is stored in association with the transaction and, in some embodiments, is provided the user when the user accesses the transaction.

In some embodiments, the method includes determining if the user is eligible for an offer based on the digital receipt; and providing the offer to the user when the user is determined to be eligible. The method may also include extracting information from the transaction record; categorizing the information extracted from the transaction record; and storing the categorized information in a formatted digital receipt, wherein a format of the formatted digital receipt is customizable by a user. In a still further embodiment, the user supplements the transaction record with a user record, wherein the user record is selected from the group consisting of an audio recording, a picture, a video, and a text note. In a yet still further embodiment, the method includes evaluating the transaction record to determine the product or process purchased; determining the supplemental information associated with the product or process purchased; and providing the supplemental information associated with the product or process purchased in the digital receipt.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a flowchart of a system and method for digital receipt management in accordance with various embodiments of the invention;

FIG. 2 is a is a flowchart of a system and method for creating a digital receipt in accordance with an embodiment of the invention;

FIG. 3 provides a block diagram illustrating a digital receipt management system and environment in accordance with various embodiments of the invention;

FIG. 4 provides a block diagram illustrating a financial institution's banking system, in accordance with an embodiment of the invention; and

FIG. 5 provides a block diagram illustrating a digital receipt mailbox, in accordance with an embodiment of the invention.

### DETAILED DESCRIPTION OF EMBODIMENTS OF THE INVENTION

The embodiments presented herein are directed to systems and methods for managing digital receipts. In some embodiments, a transaction record is received by the system. A transaction record may be an electronic receipt produced by a merchant (e.g., a merchant may email a receipt to the user after an online purchase), may be a physical receipt that is captured via a camera or scanner, may be data input into the system by the user or the merchant, or the like. The system then associates the transaction record with a user account and, if possible, a transaction in the user account. Based on the transaction record and the associated transaction, the system creates a digital receipt, which is stored in a digital receipt mailbox associated with the user. In some embodiments, the system prompts the user to provide additional information related to the digital receipt, such as the product purchased. In still further embodiments, the system offers goods and/or services based on the digital receipt. The digital receipt management system allows user to manage receipts by providing organization, value-added information related to the transaction, and special offers or reminders for the user.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Additionally, while embodiments are disclosed as “comprising” elements, it should be understood that the embodiments may also “consist of” elements or “consist essentially of” elements.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. As used herein, the term “user” includes a customer of a financial institution, a financial account holder, an agent of an account holder, a user associated with a payment device, a merchant, an employee of a merchant, a business or non-profit entity, and the like.

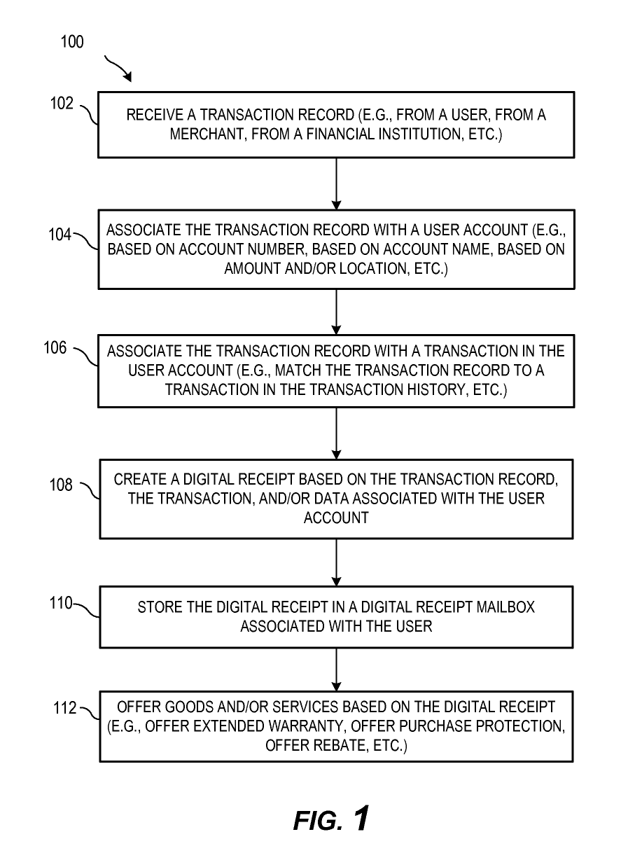

FIG. 1 is a flowchart providing an overview of a system and method 100 for managing digital receipts. It will be understood that one or more devices, such as one or more mobile device and/or one or more other computing devices and/or servers, can be configured to perform one or more steps of the system and method 100. In some embodiments, the one or more devices performing the steps are associated with a financial institution. In other embodiments, the one or more devices performing the steps are associated with a business, third party, and/or user. For example, in some embodiments, a “node” connects several networks or financial institutions such that money can be transferred from one customer of a financial institution to another customer of a different financial institution.

As illustrated at block 102, the system 100 receives a transaction record. As discussed, a transaction record may be an electronic receipt produced by a merchant (e.g., a merchant may email a receipt to the user after an online purchase), may be a physical receipt that is captured via a camera or scanner, may be data input into the system by the user or the merchant, or the like. In an exemplary embodiment, a transaction record is an electronic receipt that is created by a merchant and sent to either the financial institution or the user. If sent to the user, the user may then forward the electronic receipt to the financial institution. The transaction record may be sent via email, fax, physical mail service, text message, upload, submitted via app, and the like. The transaction record may also be a digital record provided by a merchant or financial institution. In an embodiment, the transaction record is received as text or numbers. In another embodiment, however, the transaction record is received in computer-readable format, such as binary code. In some embodiments, the transaction record is provided by a user. For example, the user may use a mobile device to take a picture of a paper receipt and then email, fax, or upload (e.g., via an app), the picture of the paper receipt to a specified digital receipt mailbox.

The transaction record information includes any information associated with the transaction. Exemplary transaction record information includes merchant name and address, store codes, merchant contact information, purchase item descriptions, product codes, purchase item price, total transaction amount, discount information, tax information, earned reward points, transaction time and date, return policy, coupons, account data, payment vehicle data, and the like. In some embodiments, the transaction record comprises at least some of the receipt data. In other embodiments, the transaction record includes the receipt data and/or additional data not included in the receipt data. For example, the additional data may include historical transaction data such as current and previous purchase trends, projected purchases data, future purchase trends, and the like.

In some embodiments, the system also receives supplemental information with the transaction record. For example, the user or merchant may record a written or text note, a voice note or voice mail, a wish list update, contact information, a hyperlink to the merchant's ecommerce site, a coupon for future use, or a video, image, or multimedia file may be appended to the transaction record. In an exemplary embodiment, a picture or video of the product or products purchased will be appended to the transaction record.

As illustrated at block 104, the system 100 associates the transaction record with a user account. The system may associate the transaction record with a user account based on information available in the transaction record. In some instances, the transaction record does not include the complete account number for the user for security purposes. For example, often a limited portion of the account number is printed on the transaction record, e.g., the last four digits. In an embodiment, this limited portion of the account number is combined with other information available in the transaction record, such as the amount, the location, or the time, to match the transaction record with a specific user account. In an embodiment, a positioning system device, such as a GPS unit in a mobile phone, is used to track the location of the user. When the user makes a purchase, such as via a mobile wallet on the mobile phone, the transaction includes a location determined by the positioning system device and can be matched a location provided on the transaction record produced by the merchant. In a further embodiment, the user account is identified based on the manner in which the transaction record is received. For example, the digital receipt mailbox may be associated with a specific user account and all receipts received in that digital receipt mailbox are associated with the user account. In an embodiment, a check is performed to determine whether there is any information, e.g., a different name or account number, on the transaction record to indicate that the transaction record was improperly assigned to the digital receipt mailbox. In a further embodiment, the email address or phone number that is used to provide the transaction record to the digital receipt mailbox is evaluated to identify the associated user account. For example, an email account forwarding the transaction record to the digital receipt mailbox may be matched to a specific user account.

In a still further embodiment, a membership, loyalty, or rewards card number may be included on the transaction record and matched to the user account. For example, a user may make a purchase at a grocery store. The user provides a loyalty card to the grocery store in advance of paying and this loyalty card number is provided on the receipt. When the receipt is provided to the system as a transaction record, the loyalty card number is matched up with information available to the system and the user account is identified. For example, the user's loyalty card number may be provided to the system by the user, by the grocery store, or by a third party processor of the loyalty card.

As illustrated at block 106, in some embodiments the system 100 associates the transaction record with a transaction in the user account. For example, the system may determine that the transaction record is associated with a specific transaction in the transaction registry of the user. Using the example of the online purchase, the purchase may show up in the transaction registry as a credit card purchase for a specific amount at a specific merchant on a specific date. The system may match a received transaction record with the transaction in the transaction registry based on the amount and location. In some embodiments, the date is given less weight than the amount and the location because the date that the transaction is processed may be different from the date that the transaction occurred. An algorithm may be used to associate the transaction record with the transaction based on the most likely transaction in a transaction history for the user account. When the user views the transaction in the user's transaction history, such as in an online register, the user may have the option to select the digital receipt and receive the digital receipt and/or the original transaction record.

In further embodiments, the transaction record may include a transaction ID or authorization ID that tracks the transaction record in the merchant's or financial institution's system. The system 100 may connect to the merchant's system over the network to receive information relating to the transaction record from the merchant or another third party.

When the system is unable to associate the transaction record with a specific transaction, the transaction record can still be stored in the digital receipt mailbox. In an embodiment, a user is able to enter the digital receipt mailbox and manipulate the transaction record to manually associate it with a specific transaction. Similarly, the user could categorize the transaction record, provide additional information relating to the transaction record that would assist the system in associating the transaction record with a transaction, or archive the transaction record.

As illustrated in block 108, the system 100 creates a digital receipt based on the transaction record, the transaction, and/or data associated with the user account. In other embodiments, another system, such as the digital receipt mailbox and/or a POS system modifies the receipt data and/or creates the digital receipt. In an embodiment, the digital receipt includes additional information beyond the information received from the transaction record. For example, the digital receipt may include supplemental information provided by the financial institution, the merchant, the user, and/or a third party.

The supplemental information provided by the financial institution may relate to the account associated with the digital receipt. For example, the supplemental information may be the current balance of the account, the balance of the account before and after the transaction, the progress towards a goal (e.g., a budget or a savings goal), a frequency statistic relating to the transaction (e.g., the number of times the user has made a purchase at the merchant, the number of times the user has made a purchase in the transaction category, and the like), and so forth. In one embodiment, the financial institution provides supplemental information related to other financial institution customers. For example, the financial institution may provide a comparison to other users. In some embodiments, the other financial institution customers are anonymous, such as when an aggregate of customers is created. A model may aggregate customers sharing characteristics with the user, such as customers that have similar gross income, similar gross expenses, or other similar demographics, and then compare the user to the aggregate. In another embodiment, a specific customer is compared to the user. In this embodiment, the specific customer must provide permission to allow another customer to access any level of financial data. In an embodiment, the specific customer may compete with the user in budgeting or transaction analysis. The digital receipts may be used to assist the user in evaluating the competition with the specific customer.

The supplemental information provided by the merchant may relate to the purchase. A purchase may be made in-store, online, via telephone, or otherwise. As used herein, the term “purchase” may not be a typical payment in exchange for goods or services, and should be construed to be any financial transaction that gives rise to a receipt. Indeed, as used herein, “purchase” may mean a charitable donation, a return of merchandise, or even a bank deposit. Thus, it should be clear that the term “purchase” does not limit the nature of financial transaction that may be the subject of embodiments of the present invention unless the context clearly indicates otherwise.

In some embodiments, the supplemental information relating to the purchase may be information identifying the product or service purchased. The supplemental information may be instructions or a manual for the product or service. The supplemental information may be a map of the location where the product was purchased or a map form the user's current location to the merchant. Maps of nearby or competing merchants may also be provided. The supplemental information may be a hyperlink to the merchant's ecommerce page or a hyperlink to the product manufacturer's page. In an exemplary embodiment, the supplemental information relating to the purchase is information relating to the warranty of the product. In another embodiment, the supplemental information is information relating to a rebate for the product. The supplemental information relating to the purchase may also be information unrelated to the product or service. For example, the supplemental information may include a coupon code for a future purchase or an indication of the number of reward points that the user earned for the purchase.

For example, in an exemplary embodiment, a warranty offer is provided to the user. The warranty offer may be from the merchant, the manufacturer, or a third party. For example, a user may purchase a product at an online website. The user receives an email acknowledgment of the transaction, including price and product purchased. This transaction record is either sent directly to the user's digital receipt mailbox or forwarded to the mailbox by the user from the user's personal email account. The system evaluates the transaction record, extracts information from the transaction record including the amount, the merchant, the product purchased, and the like. The system then attempts to associate the transaction record with a transaction in the user's transaction history. A digital receipt is created by the system, which also evaluates whether special offers are available. The system may determine that a third party provides extended warranties for the product purchased by the user and may include an offer for the extended warranty in the digital receipt. It should be understood that extended warranties are only an example of the type of special offer that may be provided to the user. For example, recall notifications may also be provided to the user when the system determines that the manufacturer of a product the user purchased has issued a recall of the product (e.g., a recall for factory defects or the like).

The supplemental information provided by the user may relate to the purchase or to the demographics or personal information of the user. In an embodiment, the supplemental information provided by the user is provided at the time of purchase. For example, the user may take a photograph of the product or service that is being offered. The user may also provide a written or voice note that is attached to the digital receipt. For example, the user may make a purchase using a mobile device and record a voice recording on the mobile device to automatically forward the voice recording to the mailbox. In some embodiments, the user inputs personal information, such as allergies, medications, likes/dislikes, a wish list, a to do list, or the like. The system evaluates the transaction record and supplements the digital receipt with information related to the user's personal information. For example, the supplemental information may include an indication that service indicated as purchased on the transaction record completes an item on the user's to do list. The user may have paid for power washing of a deck and thus the task on the user's to do list related to power washing the deck can be marked completed. Also, if the transaction record includes SKU level data, the system may determine whether any of the products purchased by the user include potential allergen risks or drug interaction risks.

The supplemental information provided by a third party may relate to special offers or recommendations. In some embodiments, a third party may provide special offers or recommendations based on the purchase. For example, the time, date, location, amount, or product or service purchased may indicate that the user is eligible for a special offer. In one example, a manufacturer may indicate that anyone who buys a specific product on a specific day is eligible for a free download. The manufacturer may work with the provider of the system to evaluate digital receipts, determine whether the digital receipt meets predetermined criteria (e.g., product purchased on specific date), and provide supplemental information such as a download link in the digital receipt.

In some embodiments, the system 100 modifies the receipt data. For example, the system 100 uses the receipt data to format the data in accordance with default preferences and/or user preferences, add or delete at least some of the receipt data to the digital receipt, calculate purchase amounts, and the like. In another example, the system may reorganize the transaction record data so that it is easier for the user to review, use the receipt data in calculations such as total amount for items in a particular category, add additional data such as transactional or account data, or delete portions of the receipt data.

In still other embodiments, the system modifies the receipt by providing subcategories for purchases compiled on the receipt. For example, the user may make a purchase at a grocery store and the receipt received from the grocery store may include the products purchased. In some embodiments, the transaction records include SKU-level data. The system may evaluate each product purchased and place the products in subcategories such as vegetables, meats, baked goods, and the like. Still further, the system may also track the user's progress towards goals or a budget based on the subcategories. For example, a user attempting to modify the user's diet may track the food subcategories purchased and be able to upload the data to a food tracking program associated with the system. In some embodiments, the digital receipt is modified so that it can be used as a gift receipt (e.g., the amount is removed from the digital receipt) and the digital receipt can be forward to a third party along with a gift.

As illustrated in block 110, the system 100 stores the digital receipt in a digital receipt mailbox associated with the user. The user may have enrolled in a digital receipt mailbox program with a provider such as a financial institution. The digital receipt mailbox may have one or more addresses to which the user can send transaction records that will then be analyzed, supplemented, and stored. A single entity may have more than one digital receipt mailbox, such as a personal digital receipt mailbox and a business digital receipt mailbox. Alternatively, a business may have a single business mailbox and multiple sub-folders in the mailbox for employees of the business. In an embodiment, business mailboxes are configured to categorize business expenses and assist the business in tracking expenses and inventory. For example, users may be able to access an online management tool where they are able to drag and drop digital receipts into specific categories, such as business expense or health care expense. The user may be able to create subcategories, such as “Trip A” within the business expense category so that the user can organize digital receipts by general category and specific events within that category. Additionally, users may be able to complete line item categorization of transactions and digital receipts to associate the digital receipt with the expense identified by the transaction in the transaction register. In some embodiments, the system provides an alert, such as an email or text message, to the user when the digital receipt is ready for viewing.

Turning now to block 112, in some embodiments the system 100 determines whether special offers are available for the user based on the digital receipt and the information received from the user. In an exemplary embodiment, the digital receipt is supplemented with extended warranties, rebates, purchase protection plans, offers, discounts, coupon codes, rewards points, awards, and so forth. In some embodiments, the digital receipt may be configured to provide reminders or automatic purchase of consumables such as printer ink, paper, food, blank disks, and the like. The digital receipt is well designed to assist in this process because the digital receipt has a record of the date of purchase and, in some cases, the item purchased and therefore estimates of duration for consumables can be made. Similarly, other time-associated products or services may be tracked by the system. For example, vehicle maintenance parts and reminders can be sent to the user based on a digital receipt for the previous instance of the maintenance (e.g., an oil change reminder can be sent to the user three months after a digital receipt for an oil change is recorded). Other types of services may also be offered. For example, tax planning or health planning services may be offered based on the data available in the digital receipts. In another example, the offer may be an ability to return at least one of the products purchased and associated with the digital receipt. In one embodiment, the digital receipt is supplemented with return instructions and/or a request form. The provider of the system also is able to extract transaction data from the digital receipts for data analysis and to assist users in managing finances. For example, the system may include optical character recognition (OCR) capabilities that allows the system to extract data from scanned or electronic receipts and create data for inclusion in digital receipts.

The system 100 may provide the offers to the user in any variety of ways. For example, the offers may be waiting for the user in the digital receipt. The offers may be sent to the user via email, regular mail, or text message. The offers may be provided to the user passively, e.g., available on a website associated with the system, or actively, e.g., pushed to the user via app or text message. The offers may be audio, video, text, or any combination thereof. It should be understood that the manner in which the offer is provided to the user can vary from those disclosed herein.

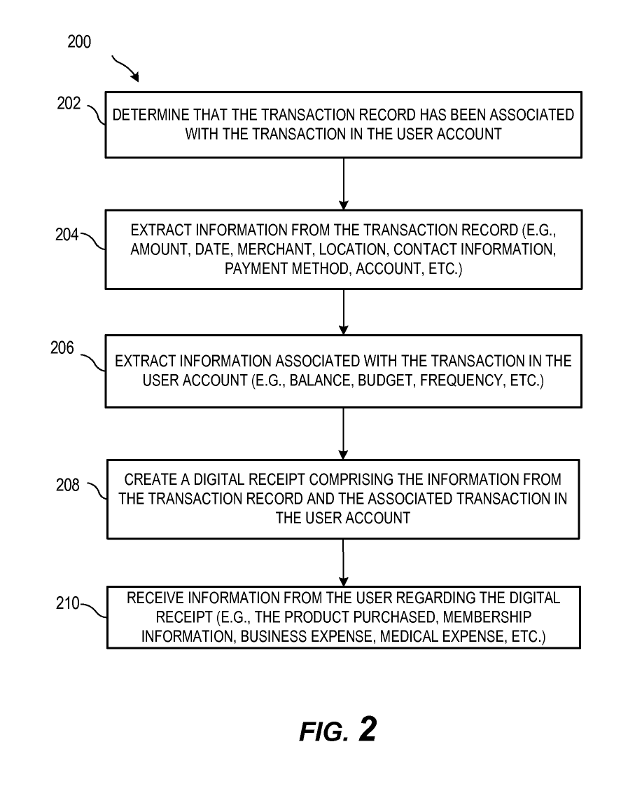

Referring now to FIG. 2, a system and method 200 for creating a digital receipt is provided in accordance with various embodiments of the invention. In some embodiments, the one or more steps of the system and method 200 are performed by a banking system, a POS device, and/or the system 100. In one exemplary embodiment, a third party payment system that is separate from the system that receives transaction records (e.g., a financial institution) and that is separate from the POS device performs the one or more steps of the system and method 200. In this way, the payment system receives the transaction record and forwards at least some of the data associated with the transaction record to a digital receipt mailbox that creates the digital receipt in coordination with additional sources of financial and/or personal data.

As illustrated in block 202, the system 200 determines that the transaction record has been associated with the transaction in the user account. As discussed in block 106, the system may match many characteristics of the transaction with transaction records to identify the specific transaction associated with the transaction record. The match can also be accomplished based on the supplemental information provided with the transaction record.

As illustrated in block 204, the system 200 extracts information from the transaction record. In an exemplary embodiment, the system extracts information using word and/or text recognition. Text and numbers are digitized and converted to a format readable by the system. In an embodiment, standard transaction record forms are identified, such as email receipts from major retailers, and the information is extracted from the forms based on location in the form. In some embodiments, the system is automated. In a further embodiment, the system is automated up to a point and then the transaction record is forwarded to an employee who evaluates the transaction record and keys in the information from the form. In an embodiment, the system evaluates the manually entered information and stores the location of the information for use in future forms. In this manner, the system learns the format of transaction records (e.g., learns the positioning of information in an email receipt) and is able to more quickly automate the extraction of information. The system 200 searches the transaction record for key words, purchase authorization codes, transaction codes, store codes, merchant codes, identifiers, and/or formulas to segregate at least some of the transaction record and extract information from the record. The system may also extract the time of the transaction, the amount, the date, the merchant, the location, contact information for the merchant, the manufacturer, or the user, the payment method (e.g., credit card, check), the payee and/or payor account, and the like.

As illustrated in block 206, the system 200 extracts information associated with the transaction in the user account. The extracted information, in some embodiments, comprises at least a portion of the transaction data that is to be included in the digital receipt. For example, the system 200 may search the transaction data to identify information that should be included in the digital receipt. For example, the transaction data may include the current balance, upcoming transfers, or the like. When the system subcategorizes products on the receipt, the system may provide a progress towards goals based on the subcategories in the transaction history of the user in the specific account or in related accounts.

As illustrated in block 208, the system 200 creates a digital receipt comprising the information from the transaction record and the associated transaction in the user account. The digital receipt may be provided in a standardized format so that the user is able to learn the format and quickly find the information the user is interested in when reviewing the digital receipts. In an embodiment, the format of the digital receipt is customizable by the user. In this way, transaction records that may be confusing and include various information in different locations, or may not include the information at all (e.g., date or location of purchase), can be standardized so that users are quickly able to review the transactions. The supplemental information also assists in standardizing the receipts across merchants and purchases.

As illustrated in block 210, in some embodiments the system 200 receives information from the user regarding the digital receipt. The user may flag the digital receipt for review, indicate that the digital receipt should be sent to a third party, or categorize the digital receipt. For example, the user may categorize the digital receipt as a business expense or a health expense. In some embodiments, the system allows the user to select a plurality of receipts based on user-defined criteria. For example, the system may also the user to search for all digital receipts categorized as business expenses. The system may allow the user to search for digital receipts based on a wide variety of information included in the digital receipts, e.g., amount, merchant, payment method, account, location, date, and the like. In some embodiments, the user is able to search based on warranty searches, serial number searches, and other information related to the product purchased.

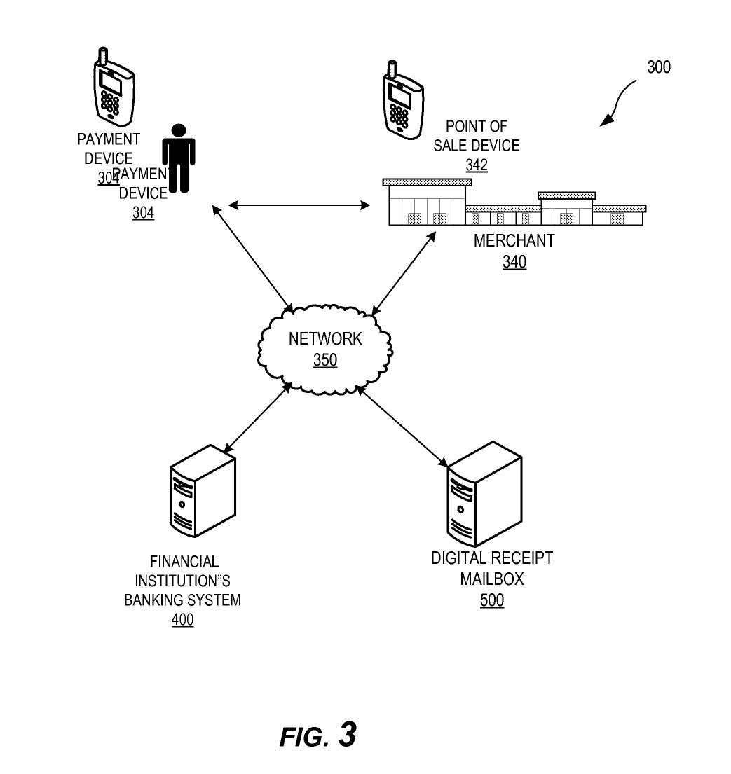

FIG. 3 provides a block diagram illustrating a digital receipt management system and environment 300, in accordance with an embodiment of the invention. As illustrated in FIG. 3, the digital receipt management environment 300 includes a user 302 and a payment device 304. The payment device may include payment vehicles such as cash, check, credit card, mobile payments, EFT transfer, reward point payments, person-to-person, person-to-merchant, and the like. A user of the system may be a person, but may also be a merchant 340 (e.g., a business), customer or a merchant, or any other entity capable of making purchases or payments. Merchants 340 conduct transactions with users 302 at point-of-sale devices 342, which may be cash registers, mobile devices, self-payment kiosks (e.g., mass transit purchases, payment for parking), or the like. The merchant may be a brick-and-mortar merchant, a mobile merchant, or an online merchant. In some embodiments, merchant information may include information relating to prior transactions associated with a particular merchant. For example, the user may have returned a product, disputed a transaction, or received a refund from the merchant during a previous period of time (e.g., the last six months). In another example, the merchant information may be based on publically available merchant reviews, whether the merchant is going out of business, and the like.

As used herein, a “mobile device” is any mobile communication device, such as a cellular telecommunications device (i.e., a cell phone or mobile phone), personal digital assistant (PDA), a mobile Internet accessing device, or other mobile device. Still further, the user 302 may conduct a transaction at a non-merchant, such as at an Automated Teller Machine (ATM).

The environment also includes at least one financial institution banking system 400 and digital receipt mailbox 500. In some embodiments, the banking system 400 includes authentication of the user in order to access the user's account on the banking system 400. For example, the banking system 400 may be a system where the user 302 logs into his/her account such that the user 302 or other entity can access data that is associated with the user 302. For example, in one embodiment of the invention, the banking system 400 is a mobile banking system maintained by a financial institution. In such an embodiment, the user 302 can log into the mobile banking system to access the user's financial accounts and in some cases the digital receipt mailbox. Logging into the banking system 400 generally requires that the user 302 authenticate his/her identity using a user name, a passcode, a cookie, a biometric identifier, a private key, a token, and/or another authentication mechanism that is provided by the user 302 to the banking system 400.

In some embodiments, the banking system comprises a third party system. For example, the banking system may include a partner, vendor, or other third party that processes payments and that is separate from a financial institution or POS device. The banking system may, for example, be a part of an online banking system or otherwise associated with the online banking system.

The financial institution's banking system 400 is in network communication with other devices, such as other financial institutions' banking systems (not shown), a payment device 304, a point of sale device 342, and a digital receipt mailbox 500. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 includes a wireless telephone mobile network (not shown). In a further embodiment, the network 350 includes a near field communication (NFC) network.

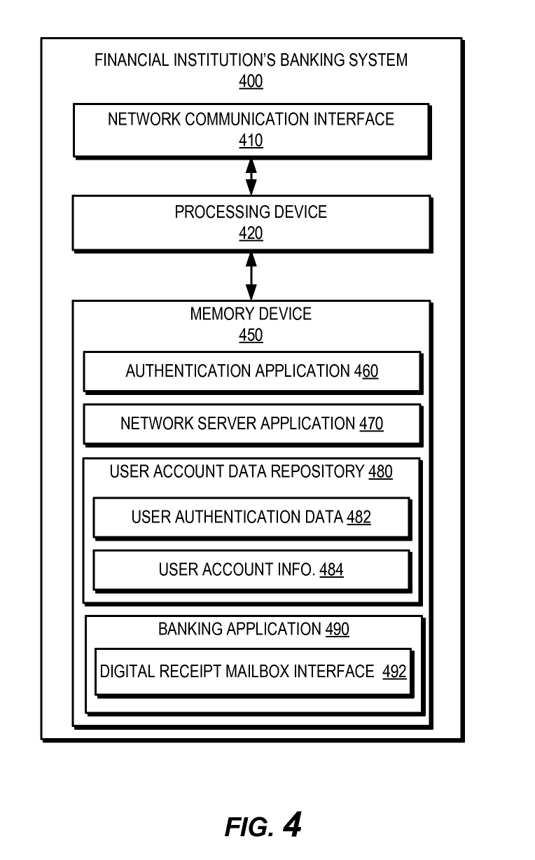

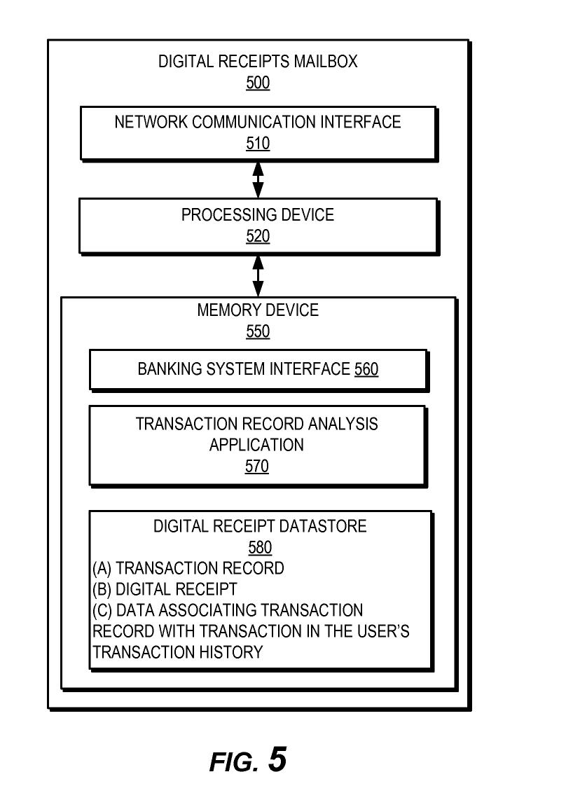

The digital receipt mailbox 500 may be a part of the financial institution banking system 400 or may be separate from the banking system 400. In some embodiments of the invention, the digital receipt mailbox 500 is configured to be controlled and managed by one or more third-party data providers (not shown in FIG. 3) over the network 350. In other embodiments, the digital receipt mailbox 500 is configured to be controlled and managed over the network 350 by the same entity that maintains the financial institution's banking system 400. The digital receipt mailbox 500 may be a portion of a server configured to store information for a single entity, such as a person or a business. The information may include the digital receipts, offers, rebate information, and the like. The financial institution banking system 400 and the digital receipt mailbox are described in greater detail below with reference to FIGS. 4 and 5, respectively.

FIG. 4 provides a block diagram illustrating the financial institution banking system 400 in greater detail, in accordance with embodiments of the invention. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

As used herein, a “processing device,” such as the processing device 420, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 420 may further include functionality to operate one or more software programs based on computer-executable program code thereof, which may be stored in a memory. As the phrase is used herein, a processing device 420 may be “configured to” perform a certain function in a variety of ways, including, for example, by having one or more general-purpose circuits perform the function by executing particular computer-executable program code embodied in computer-readable medium, and/or by having one or more application-specific circuits perform the function.

The network communications device 410 is a communication interface having one or more communication devices configured to communicate with one or more other devices on the network 350, such as the payment device 302, the point-of-sale device 342, the other financial institution banking systems (not shown), and the digital receipt mailbox 500. The processing device 420 is configured to use the network communication interface 410 to transmit and/or receive data and/or commands to and/or from the other devices connected to the network 350. As used herein, a “communication interface” generally includes a modem, server, transceiver, and/or other device for communicating with other devices on a network, and/or a user interface for communicating with one or more users.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, an authentication application 460, a user account data repository 480, which includes user authentication data 482 and user account information 484, a banking application 490, which includes a digital receipt mailbox interface 492 and a transaction record analysis application 494, and other computer-executable instructions or other data.

The authentication application 460 determines whether an entity that is logging into the financial institution banking system 400 is permitted to access the banking system 400. Entities such as individuals, businesses, and employees of businesses may provide authentication credentials to the banking system 400, which are stored in the user authentication data 482 database. When the entity attempts to access the banking system 400, the entity uses a user interface to input authentication information and this information is compared to the data stored in the user authentication data 482 to determine whether the entity is permitted to access the banking system. As used herein, a “user interface” generally includes a plurality of interface devices that allow a customer to input commands and data to direct the processing device to execute instructions. These input and output devices may include a display, mouse, keyboard, button, touchpad, touch screen, microphone, speaker, LED, light, joystick, switch, buzzer, bell, and/or other customer input/output device for communicating with one or more entities.

The network server application 470 provides functionality that allows the system to communicate over the network 350. In an embodiment, the network server application 470 utilizes the network communication interface to communicate with other devices on the network 350.

The user account data repository 480 stores user information, such as user authentication data 482 and user account information 484. The user account information may comprise a transaction history, a balance history, budgeting records (e.g., budgets for specific categories, budgets for time-limited expenses, and the like), membership or rewards information, contact information, and so on.

The banking application 490 processes transactions for the user. The banking application 490 may also include a digital receipt mailbox interface 492. The digital receipt mailbox interface 492 facilitates communication between the banking system 400 and the digital receipt mailbox 500.

FIG. 5 provides a block diagram illustrating a digital receipt mailbox 500, in accordance with an embodiment of the invention. In one embodiment of the invention, the digital receipt mailbox 500 is operated by a second entity that is a different or separate entity from the first entity (e.g., the financial institution) that, in one embodiment of the invention, implements the banking system 400. In one embodiment, the digital receipt mailbox 500 could be part of the banking system 400. In another embodiment, the digital receipt mailbox 500 is a distinct entity from the banking system 400.

As illustrated in FIG. 5, the digital receipt mailbox 500 generally includes, but is not limited to, a network communication interface 510, a processing device 520, and a memory device 550. The processing device 520 is operatively coupled to the network communication interface 510 and the memory device 550. In one embodiment of the digital receipt mailbox 500, the memory device 550 stores, but is not limited to, a banking system interface 560, a transaction record analysis application 570, and a digital receipt data store 580. The transaction record analysis application 570 analyzes transaction records, such as a transaction request or receipt received from a merchant or user, and extracts information from them. The transaction record analysis application 570 may extract the amount, the location, the date, the merchant, the category, and/or the payee account from the transaction record. In an embodiment, the transaction record analysis application 570 also extracts the product purchased from the transaction record. In some embodiments, the transaction record analysis application also creates the digital receipts from the transaction record.

The digital receipt data store 580 stores data including, but not limited to, the transaction records received for the user (e.g., the email receipts from online merchants, the images of receipts scanned and sent to the digital receipt mailbox by the user, and the like), the digital receipts created for the user, and data associating the transaction records and digital receipts with transactions in the user's transaction history.

The network communication interface 510 is a communication interface having one or more communication devices configured to communicate with one or more other devices on the network 350. The processing device 520 is configured to use the network communication interface 510 to receive information from and/or provide information and commands to a payment device 304, other financial institution banking systems (not shown), the point-of-sale device 342, the banking system 400, and/or other devices via the network 350. In some embodiments, the processing device 520 also uses the network communication interface 510 to access other devices on the network 350, such as one or more web servers of one or more third-party data providers

As described above, the processing device 520 is configured to use the network communication interface 510 to gather data from the various data sources. The processing device 520 stores the data that it receives in the memory device 550. In this regard, in one embodiment of the invention, the memory device 550 includes data stores that include, for example: (1) transaction records, such as email receipts, images of receipts, and the like; (2) algorithms for determining an account number from information extracted from the transaction record (3); digital receipts created from the transaction records and/or the transaction history of the user; (4) data associating the digital receipts and/or transaction records with transactions in the user's transaction history; and/or (5) special offers or reminders related to the digital receipt, transaction record, or products associated with the transaction.

As will be appreciated by one skilled in the art, aspects of the present embodiments of the invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the invention are described below with reference to flowchart illustrations and/or block diagrams of methods, apparatus (systems) and computer program products according to embodiments of the embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for managing digital receipts, the system comprising:
a computer apparatus including a processor and a memory; and
a digital receipt management software module stored in the memory, comprising executable instructions that when executed by the processor cause the processor to:
receive a transaction record, wherein the transaction record comprises information relating to a transaction;
determine a user account associated with the transaction record based on the information;
associate the transaction record with a transaction in the user account, wherein the user account comprises an account history;
extract information from the transaction record, wherein the information comprises at least one of a time of the transaction, an amount of the transaction, a date of the transaction, a merchant associated with the transaction, a location of the transaction, a payment method, a payee account, and a payor account;
determine a category for the transaction based on the information in the transaction record;
create a digital receipt based on the transaction record and the account history, wherein the digital receipt comprises the category;
store the digital receipt in association with the transaction; and
provide the digital receipt to the user when the user accesses the transaction.

2. The system of claim 1, wherein the module is further configured to determine if the user is eligible for an offer based on the digital receipt.

3. The system of claim 2, wherein the module is further configured to provide the offer to the user when the user is determined to be eligible.

4. (canceled)

5. The system of claim 1, wherein a format of the formatted digital receipt is customizable by the user.

6. The system of claim 1, wherein the user supplements the transaction record with a user record.

7. The system of claim 6, wherein the user record is selected from the group consisting of an audio recording, a picture, a video, and a text note.

8. The system of claim 1, wherein the module is further configured to:
evaluate the transaction record to determine the product or process purchased;
determine supplemental information associated with the product or process purchased; and
provide the supplemental information associated with the product or process purchased in the digital receipt.

9. A computer program product for managing digital receipts, the computer program product comprising:
a non-transitory computer readable storage medium having computer readable program code embodied therewith, the computer readable program code comprising:
a computer readable program code configured to receive a transaction record, wherein the transaction record comprises information relating to a transaction;
a computer readable program code configured to determine a user account associated with the transaction record based on the information;
a computer readable program code configured to associate the transaction record with a transaction in the user account, wherein the user account comprises an account history;
a computer readable program code configured to extract information from the transaction record, wherein the information comprises at least one of a time of the transaction, an amount of the transaction, a date of the transaction, a merchant associated with the transaction, a location of the transaction, a payment method, a payee account, and a payor account;
a computer readable program code configured to determine a category for the transaction based on the information in the transaction record;
a computer readable program code configured to create a digital receipt based on the transaction record and the account history, wherein the digital receipt comprises the category;
a computer readable program code configured to store the digital receipt in association with the transaction; and
a computer readable program code configured to provide the digital receipt to the user when the user accesses the transaction.

10. The computer program product of claim 9, the computer program product further comprising a computer readable program code configured to determine if the user is eligible for an offer based on the digital receipt.

11. The computer program product of claim 10, the computer program product further comprising a computer readable program code configured to provide the offer to the user when the user is determined to be eligible.

12. (canceled)

13. The computer program product of claim 9, wherein a format of the formatted digital receipt is customizable by the user

14. The computer program product of claim 9, wherein the user supplements the transaction record with a user record.

15. The computer program product of claim 14, wherein the user record is selected from the group consisting of an audio recording, a picture, a video, and a text note.

16. The computer program product of claim 9, the computer program product further comprising computer readable program code configured to:
evaluate the transaction record to determine the product or process purchased;
determine supplemental information associated with the product or process purchased; and
provide the supplemental information associated with the product or process purchased in the digital receipt.

17. A method for managing digital receipts, the method comprising:
using a computer processor comprising computer program code instructions stored in a non-transitory computer readable medium, wherein said computer program code instructions are structured to cause said computer processor to:
receiving a transaction record, wherein the transaction record comprises information relating to a transaction;
determining, via a computing device processor, a user account associated with the transaction record based on the information;
associating the transaction record with a transaction in the user account, wherein the user account comprises an account history;
extracting information from the transaction record, wherein the information comprises at least one of a time of the transaction, an amount of the transaction, a date of the transaction, a merchant associated with the transaction, a location of the transaction, a payment method, a payee account, and a payor account;
determining a category for the transaction based on the information in the transaction record;
creating, via a computing device processor, a digital receipt based on the transaction record and the account history, wherein the digital receipt comprises the category;
storing the digital receipt in association with the transaction; and
providing the digital receipt to the user when the user accesses the transaction.

18. The method of claim 17, the method further comprising:
determining if the user is eligible for an offer based on the digital receipt; and
providing the offer to the user when the user is determined to be eligible.

19. (canceled)

20. The method of claim 17, wherein the user supplements the transaction record with a user record, wherein the user record is selected from the group consisting of an audio recording, a picture, a video, and a text note.

21. The method of claim 17, the method further comprising:
evaluating the transaction record to determine the product or process purchased;
determining the supplemental information associated with the product or process purchased; and
providing the supplemental information associated with the product or process purchased in the digital receipt.
